(19) United States
(12) Patent Application Publication
(10) Pub. No.: US 2012/0328161 A1
(43) Pub. Date: Dec. 27, 2012

(54) METHOD AND MULTI-SCALE ATTENTION SYSTEM FOR SPATIOTEMPORAL CHANGE DETERMINATION AND OBJECT DETECTION

(76) Inventors: Roman PALENYCHKA, Gatineau (CA); Marek ZAREMBA, Ottawa (CA)

(21) Appl. No.: 13/530,981

(22) Filed: Jun. 22, 2012

Related U.S. Application Data
(60) Provisional application No. 61/499,952, filed on Jun. 22, 2011.

(51) Int. Cl. G06K 9/62

(52) U.S. Cl. 382/107

(57) ABSTRACT

A method and multi-scale attention system for the detection of objects and temporal change regions by a spatiotemporal attention operator of an image sequence, which linearly aggregates temporal change filter with spatial saliency filter and includes an extractor of salient maxima, which selects consecutive salient maxima of the spatiotemporal operator to produce the locations of the objects of interest and the centers of temporal change regions. The concept of spatial local scale introduced into the system and method for its determination allows for a scale-adaptive integration of the temporal change with spatial saliency and effective detection of different in size and location objects of interest. Can be used for object and spatiotemporal change detection in monitoring pollution, natural disasters, weather conditions and environmental changes based on satellite remote sensing imagery from various sensors.

### CROSS REFERENCE TO RELATED APPLICATIONS

This application claims the benefit of priority from U.S. Provisional Patent Application No. 61/499,952 filed Jun. 22, 2011, the disclosure of which is expressly incorporated herein by reference in its entirety.

### FIELD OF THE INVENTION

The present invention relates to an object detecting method and system, which detects objects of interest and their salient parts by a spatiotemporal attention operator acting on an image or an image sequence obtained by a camera or another source of imagery data such as multi-temporal remote sensing systems.

### BACKGROUND OF THE INVENTION

In different surveillance applications including remote sensing monitoring based on satellite sensors, it is desirable to have an indication of the presence of objects of interests or temporal changes occurred most recently with respect to the observation period. A video camera can be used as an image sensor, which produces a sequence of images—frames, which are processed in a system to detect objects of interest. In remote sensing applications, different types of sensors are used to capture properties of particular objects of interest, for example multi-spectral sensors, radar sensors or LiDAR detection technology. SAR (Synthetic Aperture Radar) sensor technology became popular in remote sensing due to its minimal dependence on weather conditions, especially cloud cover, and the possibility to perform monitoring at night time.

Object detection is a process of locating objects of interest, still or moving, in a single image or image sequence. The existing object detection methods and corresponding computing systems, hardware and software-based, are mostly oriented on detection of still objects only in a single image or solely moving objects based on a given sequence of images or video data. Many of these systems for still object detection are based on object edge or corner detectors, implementation of an image segmentation method, texture analysis, shape feature extraction, and others. The recognition process often applies learning methods, such as neural networks and support vector machines that must be trained with sets of known (labeled) input data. These methods and systems of still object detection often fail in the conditions of low resolution and contrast of images, variable size of the objects of interest, occlusions, and presence of random perturbations such as noise and texture.

One promising approach to object detection is the visual attention method, which imitates the human visual system to robustly and time-efficiently locate multiple objects of interest with different sizes on a complex and often distractive background. A visual attention operator is the basic method to determine the most probable locations for the presence of an object of interest, moving or still. The maxima points of a visual attention operator are usually selected as the most probable object locations. Further image analysis and feature extraction is performed in these pixel locations for final decision making. Multi-scale image analysis, such as the multi-resolution Laplacian-of-Gaussian operator and wavelet transforms, is proposed for attention operators in order to enable detection of objects having different sizes and different image locations. In the monitoring applications, however, a visual attention operator has to be sensitive to temporal change to react in the first place on a moving object and occurring temporal changes. But it also has to be sensitive to salient image locations containing objects of interest or their salient parts in order to detect still objects.

Fast and accurate extraction of temporal changes in an image sequence containing objects of interest is the basic method for moving object detection. Existing systems and algorithms for temporal change determination and moving object detection can be classified into three major methods: background subtraction, temporal differentiation, and direct estimation of optical flow. The popular method of background subtraction supposes a reference static background to be known or estimated based on a training sequence. It is subtracted from the current image in a pixel-by-pixel fashion to obtain moving object regions or temporal change areas. An advantageous characteristic of the background subtraction is that the entire connected regions of moving objects become available after the subtraction. The main disadvantage is its sensitivity to the reference background image, which may be unavailable or too unstable. The simple method of local temporal differentiation is not based on a reference background image and uses neighboring frames of the same scene. However, the conventional temporal differentiation provides only parts, such as edges, of moving homogeneous regions and objects of interest and is sensitive to irrelevant intensity changes. Motion detection based on the optical flow computation is a versatile and local method to determine image regions where changes have occurred. Optical flow is the pattern of apparent motion of objects, surfaces, and edges in a visual scene caused by the relative motion between a sensor and the scene. In previously-known systems and detection methods, tracking moving objects has been typically achieved by combining algorithms to solve several different problems independently. The main problems to be solved in tracking—based object detection are initial object detection, object tracking, and object classification.

Feature-based methods using spatial features (edges, corners, blobs, homogeneous regions, etc.) are proposed to improve the stability of moving object detection. In particular, the method of corner detection and tracking was developed to effectively detect moving objects. The existing approach of feature tracking is limited to detection and tracking of particular features, which may be undetectable in the objects of interest due to various geometrical transformations, poor image resolution, and relative object spatial positions with respect to the sensors.

An effective combination of temporal change features with the spatial saliency detectors and visual attention operators in a single detector system is not solved in the prior art of object detectors.

### SUMMARY

It is an object of the present disclosure to obviate or mitigate at least one disadvantage of previous object detection systems.

In a first aspect, there is provided a method and multi-scale attention system comprising a selector of spatial local scale connected with the local scale input of the spatial saliency filter and connected with the local scale input of the temporal change filter, which receive at their inputs an input image sequence, and their outputs are combined using a temporal gain coefficient in the block of spatiotemporal attention operator, which is further connected to the filter of salient maxima, which output indicates the coordinates of centers of objects of interest or temporal change regions in the image sequence.

According to an embodiment of the present aspect, the spatial saliency filter can include the block of averaging filters using a disk averaging window and ring averaging window, which are linearly combined in the isotropic contrast operator to estimate the local isotropic contrast. The spatial saliency determinator computes the local variance in the disk window and subtracts it from the output of the isotropic contrast operator to produce the spatial saliency level in the current location of the input image sequence. In another embodiment, the temporal change filter includes the temporal differentiation filter, which is connected with the scale-adaptive spatial filter, which output produces the temporal change level in the current location of the input image sequence. In yet another embodiment, the selector of spatial local scale is composed of a bank of R blocks of the local averaging filters connected with R estimators of contrast-to-variance ratio, which outputs are connected with R inputs of the maximum selector, which output provides the spatial local scale value, where R is the total number of spatial local scales.

According to another embodiment of the present aspect, spatial local scale is determined in each image point and is an estimate for the local size of the objects of interest, which thereafter is used to determine the spatial saliency level and the temporal change level in all image points of the input image sequence. Furthermore, the spatial saliency level in each image point is determined by the ratio of the local isotropic contrast to the local variance over a circular region, which diameter is equal to the spatial local scale value in pixels for the corresponding image point. In yet a further embodiment, the system can include a spatiotemporal attention operator, which adds the temporal change level multiplied by the temporal gain coefficient to the spatial saliency level, which is at the output of the spatial saliency filter. A salient maxima filter is included in the present embodiment, which includes a local maximum selector and a saliency comparator connected through the logical “and” operation to the input of the coordinate indicator, which output is the object location point in the image sequence or center of the temporal change region in the image sequence; another input of the saliency comparator is fed by the saliency threshold.

According to aspects of the present embodiments, the temporal differentiation filter implements the second-order discrete differentiation by linearly combining current image frame, previous image frame and next image frame with the corresponding coefficients to form the output of the temporal differentiation filter. The computation of the local isotropic contrast, local variance and spatial saliency level proceeds in a multi-scale mode for all the R spatial local scales, where R is the total number of spatial local scales, and the total number of the spatial local scales R is selected so to cover all the possible local sizes of the objects of interest and temporal change regions to be detected.

### BRIEF DESCRIPTION OF THE DRAWINGS

Embodiments of the present disclosure will now be described, by way of example only, with reference to the attached Figures.

FIG. 1 is a block diagram of an object detection system, according to a present embodiment;

FIG. 2 is a block diagram of the spatial local scale selector of FIG. 1, according to a present embodiment;

FIG. 3 is an illustration of an example of local isotropic contrast and temporal change of a moving rectangle;

FIGS. 4A, 4B, 4C and 4D are examples of image fragments with various levels of radial symmetry;

FIG. 5 is a block diagram of the temporal differentiation filter shown in FIG. 1, according to a present embodiment;

FIG. 6 is a block diagram of the spatiotemporal attention operator shown in FIG. 1, according to a present embodiment; and,

FIG. 7 is a block diagram of the salient maxima filter shown in FIG. 1, according to a present embodiment.

### DETAILED DESCRIPTION

The present embodiments are aimed at improving the performance and functional capabilities of visual attention systems for object detection. It is achieved in the present embodiments by multi-scale image analysis and scale-adaptive linear combination of temporal change filter with the spatial saliency filter in a single spatiotemporal attention operator. As a result, the proposed multi-scale attention system embodiments provides detection of multiple objects of interest both still and moving, which can have different sizes and spatiotemporal locations in the input image sequence.

Objects of interest can automatically be detected based on their images taken in different sequential moments of time, which are obtained by image sensors of various physical natures. In the present invention, a video camera is one of possible sources of images as a sequence of frames taken in consecutive time moments, with the frequency of 30 frames per second by example. Another source of image sequences are remote sensing images, obtained for the same geographical area in different moments of time by sensors installed on an earth observation satellite, which can be based on various physical principles of image formation such as the SAR (Synthetic Aperture Radar) imagery. In contrast to video cameras, the frame frequency of earth observation for object detection can be of the order of only one frame per 1-2 days. The resolution of the images can vary, depending on the sensor technology. The average image resolution used in the currently available SAR sensors is 50 m per pixel. In application to sea ice detection using satellite SAR image sequences, the objects of interest are sea ice regions in Arctic coastal areas, which also can have different categories to be recognized, such as fast ice, moving ice, snow-covered ice, old ice, etc. By analyzing image sequences with an appropriate spatial resolution and frame frequency and applying an effective object detection method, the object(s) of interest such as sea ice regions for example, can be automatically detected and displayed to the end users for final decision making of the object category.

The present embodiments include applying a multi-scale spatiotemporal operator to an image or a sequence of images to compute the attention map, which will produce another image in which the intensity is proportional to the amount of temporal change and spatial saliency level in the corresponding locations of the image sequence. A set of consecutive salient maxima of the attention map—called attention points—indicate positions of the objects of interest, i.e., spatial coordinates and frame indicator for each spatiotemporal image location. For example, such position indicators can take the form of annotations overlayed on an image from which objects are detected. Such annotations can be colour coded, and be of any shape or size.

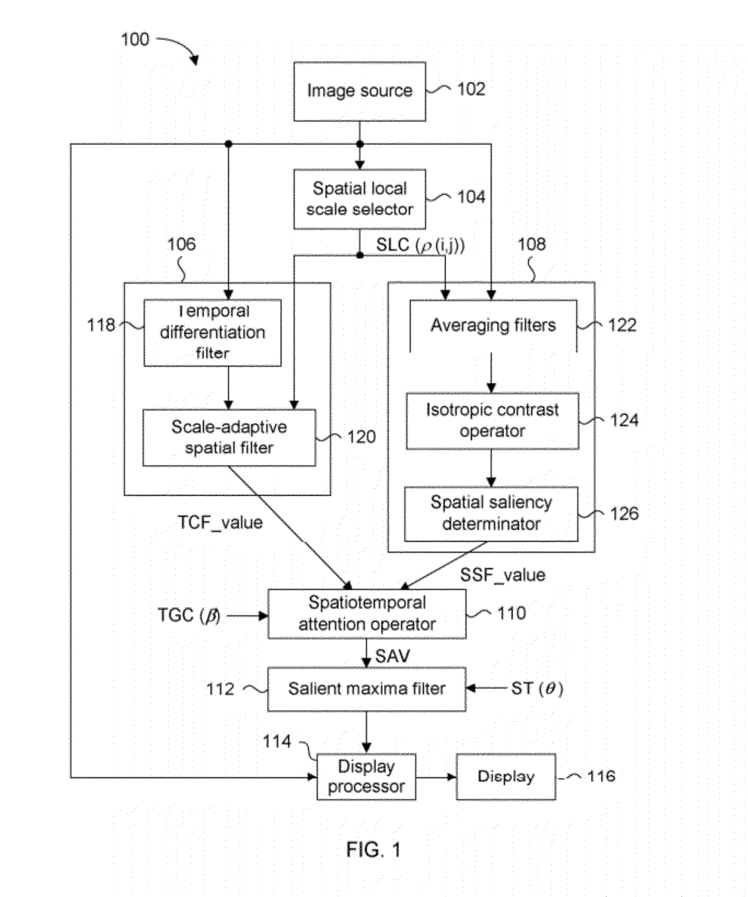

A block diagram of the object detection system, according to a present embodiment, is shown in FIG. 1. The object detection system 100, also referred to as a multi-scale attention system, includes several components, including an image source 102, a spatial local scale selector 104, a temporal change filter 106, a spatial saliency filter 108, a spatiotemporal attention operator 110, a salient maxima filter 112, a display processor 114 and a display 116. The temporal change filter 106 includes sub-components including a temporal differentiation filter 118 and a scale-adaptive spatial filter 120. The spatial saliency filter 108 includes sub-components including averaging filters 122, an isotropic contrast operator 124, and a spatial saliency determinator 126. Following is a general discussion of the function of the aforementioned components of the object detection system 100. Generally, the object detection system 100 processes pixel intensities of a received input frame image in gray-scale values, from 0 to 255 by example. Each pixel is processed, where the object and region coordinates are in pixels with respect to an image coordinate system, which can have particular spatial resolution of the imaging (remote sensing system), for example at 50 m per pixel.

The image source 102 can include any type of image capture device, such as a video camera, or a source of images, such as a database of previously stored images or video images. Regardless of the actual type of image capture device being used, the image source 102 provides digital image data, where pixels of the image have associated grey shade pixel intensity values, colour values, or other associated intensity values. In the present embodiment, the image source provides a sequence of frames of an area of interest, where each frame is an image of the area of interest captured at different times. Each frame provided by the image source 102 is provided to the spatial local scale selector 104, the temporal change filter 106, and the spatial saliency filter 108, for further processing of the pixels. Each frame can optionally be provided to a display processor 114.

The spatial local scale selector 104 uses the received frame to determine the best scale to use based on the best contrast to variance ratio for a range of predetermined scales. For example, a potential object represented by 10 pixels at one scale factor may have a better contrast to variance ratio than the same potential object represented by 4 pixels at a low scale factor. The selected local scale output SLC, is provided to the temporal change filter 106, and the spatial saliency filter 108. The output of spatial local scale selector 104 is the value (index) of the spatial local scale in a current image point. It is used by scale-adaptive spatial filter 120 to set a window size to be used. Further details of the spatial local scale selector 104 are discussed later.

The temporal change filter 106 is configured for determining a strength of temporal change in features in the sequence of received images. In otherwords, a displacement of the feature or a change in size of the feature between frames is detected by temporal change filter 106. For example, large objects such as icebergs may shift position with ocean currents. In another example, bodies of water such as lakes can contract or shrink in a drought situation, or expand in a flood situation. In the present embodiment, the temporal differentiation filter 118 samples at least two consecutive frames and compares them to each other in order to determine if pixels at the same locations of each frame have changed intensity values or not. The level of difference indicates the presence of movement of one or more features. A temporal change value corresponding to each pixel position of the frames being compared is provided to the scale-adaptive spatial filter 120. The scale-adaptive spatial filter 120 then executes spatial integration, or a summing of all temporal change values within a window centered in the current image point. The window size in the scale-adaptive spatial filter 120 is determined by the spatial local scale selector 104 for the current point. For example, the window size of the spatial integration will be large for large sized objects.

Ultimately, temporal change filter 106 provides the temporal change level in a current image location, which is proportional to the velocity of object movement or object (region) size (and non-rigid shape) change quantity during the observation period, and in that location. The observation period is determined by the frame frequency and number of consecutive frames used in the temporal differentiation filter.

Hence the detection of temporal changes to features in the image frames increases the probability of the feature being an object. Further details of the temporal change filter 106 are discussed later.

The spatial saliency filter 108 is configured for determining a level of distinctiveness of a feature within the images, relative to the background within which the feature appears. The output of spatial local scale selector 104 is the spatial local scale, which determines the window size of the averaging filters 122 in the spatial saliency filter 108. While the temporal change filter 106 provides a value representing the potential likely hood that a moving feature between frames is an object, the spatial saliency filter 108 analyses a frame to determine a feature within the context of a frame as being an object distinct from the rest of the image. In the present embodiment, the averaging filters 122 compute average intensity value (mean intensity) and average squared intensity value within the window determined by spatial local scale selector 104, for each image point. These two values are later used to determine the local isotropic contrast and local variance to determine the spatial saliency level at the output of 108. The isotropic contrast operator 124 can then determine if the feature has a uniform contrast using the average intensity value, and consequently the size and general shape of the feature. In the present embodiments, the geometric shape of a disc with a surrounding ring region is used to estimate the local isotropic contrast of a feature of interest. The spatial saliency determinator 126 is responsible for determining a local variance in the window of the disc using the average squared intensity value, and subtracting it from the isotropic contrast operator output to produce a spatial saliency level in the region of the feature of interest.

The spatial local scale operator 104, the temporal change filter 106, and the spatial saliency filter 108 can be implemented in a hardware system with dedicated circuits configured to execute the described operations in parallel for maximizing performance and throughput. Alternately, these components can operate in a sequential order.

The values provided by the temporal change filter 106 (TCF_value), and the spatial saliency filter 108 (SSF_value) are provided to spatiotemporal attention operator 110, which also receives a temporal gain coefficient value TGC (β). This value can be predetermined or set by an operator for increasing the weighting value of the output of the temporal change filter 106. In otherwords, for certain applications, it may be more important for the system to identify moving objects, or objects that are changing in shape or size. The spatiotemporal attention operator 110 combines the value of the spatial saliency filter 108 with the temporal gain modified value from the temporal change filter 106 to provide a final output, referred to as the spatiotemporal attention value (SAV).

The SAV is received by the salient maxima filter 112 for determining if the SAV meets at least one predetermined condition. Such predetermined conditions include, but are not limited to, SAV being at least a minimum saliency threshold value ST (θ), or the SAV being a local maximum saliency for the area around the current image point. In the case where one or more of the conditions are met, then the system has determined that the image point being analyzed is an object point. The salient maxima filter 112 then provides coordinates corresponding to the pixel in the image.

Finally, the display processor 114 is configured to generate display annotations at the coordinates provided by salient maxima filter 112, which can be overlayed onto a source image for visual presentation to a user on display 116.

In order to achieve optimal detection results for the case of multiple objects with different sizes and locations in images, the present embodiments introduces the concept of spatial local scale and a method of its estimation based on the available image data. The local size of an object or image region is associated with the concept of image local scale in a particular image point. The spatial local scale ρ(i,j,k) is determined in the point (i,j) of the kth frame as the diameter of the region-inscribed disk centered at (i,j), which has the maximum value a saliency measure over a given scale range R as the total number of all scales currently used. In particular, local contrast-to-variance ratio is a measure of the spatial saliency level in a given image location. The spatial local scale determines the optimal window size in the averaging filter of the temporal change filter applied to estimate the temporal change level in point (i,j,k). It is also used to estimate the window size in the computation of the local isotropic contrast and local variance in the spatial saliency filter. The spatial local scale is determined by the maximum spatial saliency level rule in a given image location (i,j,k):

$$ρ ( i , j , k ) = arg {max}_{1 \leq r \leq R} \{ {c}_{r} ( i , j , k ) / {d}_{r} ( i , j , k ) \} , \qquad ( 1 )$$

where cᵣ(i,j,k) is the estimate of the local isotropic contrast dᵣ(i,j,k) is the local variance as an estimate of the region non-homogeneity in point (i,j,k) and at rth local scale, where r=1, . . . , R. The spatial local scale selector 104 of FIG. 1 executes the local scale determination according to Eq. (1).

The spatiotemporal attention operator 110 of the present embodiments is a multi-scale attention operator, which is applied to the input image sequence {f(i,j,k)} and produces an attention map after prior selection of the spatial local scale according to Eq. (1). This operator aggregates the temporal change filter with the temporal gain coefficient β and the spatial saliency filter at the spatial local scale p determined in the selector of spatial local scale:

F[f(i,j,k),ρ]=c_{ρ}(i,j,k)−d_{ρ}(i,j,k)+β·e_{ρ}(i,j,k), (2)

where (i,j,k) are the spatial point coordinates (i,j) for kth frame, c_{ρ}(i,j,k) is the estimate of the local isotropic contrast in (i,j,k), d_{ρ}(i,j,k) is the estimate of the region non-homogeneity, e_{ρ}(i,j,k) is the temporal change estimate in (i,j,k) and β>0. The initial value for the temporal gain coefficient is β=1. The derivation of the optimized value for β in the maximum-likelihood sense can be implemented assuming appropriate distributions of the three terms in Eq. (2) as random independent variables at the condition of a moving object or temporal change presence in the location (i,j,k).

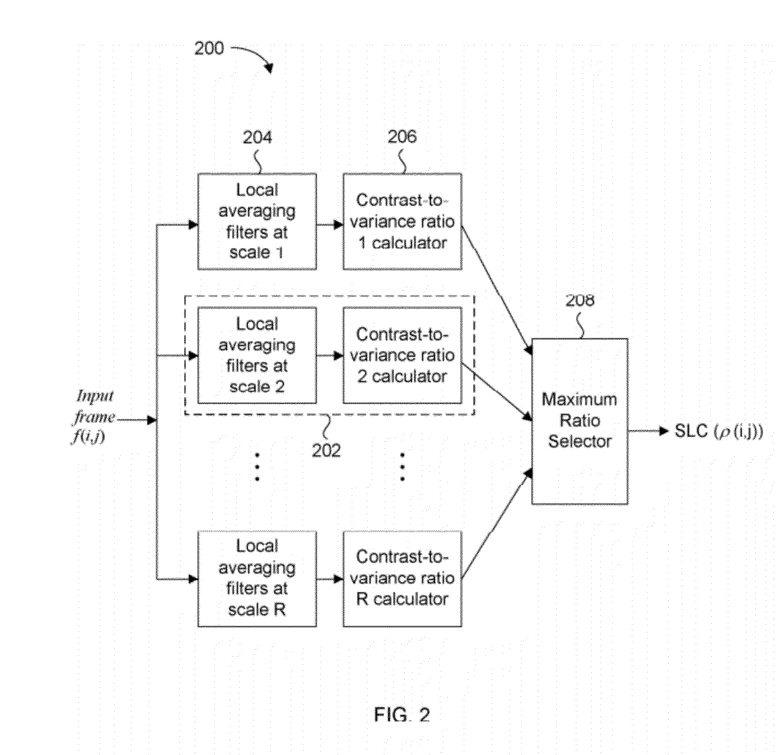

FIG. 2 is a block diagram of the spatial local scale selector 104 of FIG. 1, according to a present embodiment. In FIG. 2, the spatial local scale selector 200 includes multiple image scale processors 202, of which only one is annotated as such in FIG. 2. In the present example, each image scale processor 202 determines a contrast to variance ratio for an image at a different scaling factor. Scale factors of sequential integer numbers starting at 1 up to a maximum R are used in the present example, but any increasing scale pattern can be used. Each image scale processor 202 includes a local averaging filter 204 for a specific scale, and a contrast to variance ratio calculator 206. In the present embodiment, all image scale processors 202 operate on the same input image concurrently. The local averaging filter 204 processes the image to determine average pixel intensities in the image at the selected scale. The contrast to variance ratio calculator 206 then determines the spatial saliency level of the filtered image. All the spatial saliency level values from each contrast to variance ratio calculator 206 is provided to a maximum ratio selector 208, that determines which of the received values is the optimal one. The optimal value in the present example would be the highest spatial saliency level, ie. the highest contrast to variance ratio for a specific scale. This selected optimal value is then output as SLC (ρ(i,j)).

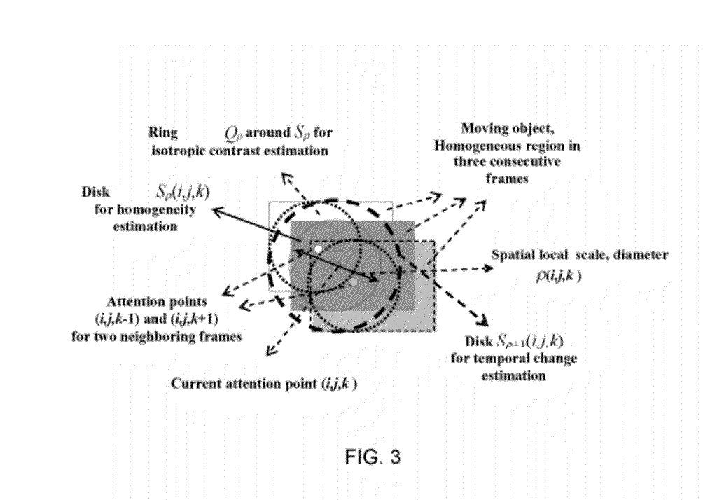

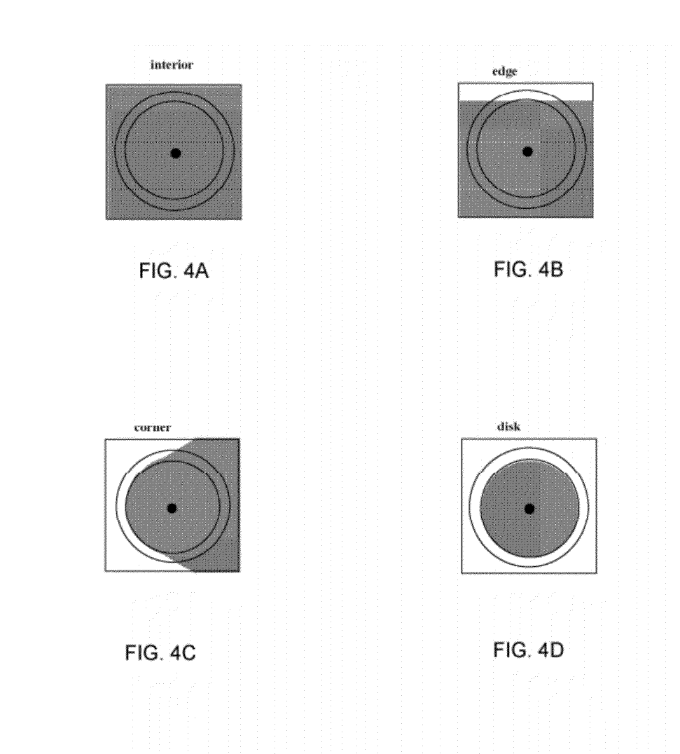

The spatial saliency filter 108 of the system of FIG. 1 implements the computation of first two terms in Eq. (2). The first term in Eq. (2) is called local isotropic contrast and is defined in such a way that it provides two attention tokens at the same time: local isotropic contrast and shape radial symmetry. The shape radial symmetry serve as the measure object shape saliency, which contributes to the amount of spatial saliency in the location (i,j,k). Two concentric windows are involved in the estimation of the local isotropic contrast: disc window S_{ρ} and ring window Q_{ρ}=S_{ρ+1}\S_{ρ}. Examples of these windows are shown in FIG. 3. FIG. 3 is an illustration of an example of local isotropic contrast and temporal change of a moving rectangle as a feature of interest. The local isotropic contrast c(i,j,k,p) at the ρth scale in (i,j,k) is estimated as the mean square deviation in the ring window Q_{ρ}(i,j,k) with respect to the mean intensity of the disk window S_{ρ}(i,j):

$${c}_{ρ}^{2} ( i , j , k ) = \frac{1}{\vert {Q}_{ρ} \vert} {\sum }_{m , n ∈ {Q}_{ρ} ( i , j )} {( {a}_{ρ} ( i , j , k ) - f ( m , n , k ) )}^{2} , \qquad ( 3 )$$

where a_{ρ}(i,j,k) stands for the mean value of f(i,j,k) in S_{ρ}(i,j) and |Q_{ρ}| is the total number of pixels in Q_{ρ}(i,j). The intensity deviation in the ring P_{ρ} will be proportional to the amount of edge points of the greatest inscribed structuring element S_{ρ} since the window Q_{ρ}(i,j) will include background points near the region border. It measures the level of radial symmetry around (i,j,k) for a homogeneous region of an object of interest. In contrast to the concept of central symmetry, the radial symmetry level is defined as being directly proportional to the number of tangent edges located at the same radial distance to the center of inscribed homogeneous disk. Examples of image fragments with different levels of radial symmetry are illustrated in FIGS. 4A, 4B, 4C and 4D, where the shaded areas represent high contrast relative to the white areas within each window.

The number of background edge pixels in Q_{ρ}(i,j) is equal to zero for the interior region of FIG. 4A, such as at the centre of a feature, while a round object such as the disk in FIG. 4D yields the maximum of the radial symmetry level. Similarly, the radial symmetry will be higher at corner locations, such as the single corner location shown in FIG. 4C and contribute to higher values of the local isotropic contrast in Eq. (3). The estimation of the local isotropic contrast is time-efficiently implemented in the isotropic contrast operator 124 of FIG. 1 as a linear combination of averaging filters at the output of the block of averaging filters:

$${c}_{ρ}^{2} ( i , j , k ) = {a}_{ρ}^{2} ( i , j , k ) - 2 \cdot {a}_{ρ} ( i , j , k ) \cdot \frac{1}{\vert {Q}_{ρ} \vert} {\sum }_{m , n ∈ {Q}_{ρ} ( i , j )} f ( m , n , k ) + \frac{1}{\vert {Q}_{ρ} \vert} {\sum }_{m , n ∈ {Q}_{ρ} ( i , j )} {f}^{2} ( m , n , k ) , \qquad ( 4 )$$

where the last two terms in Eq. (4) contain the averaging filters of image intensity f(m,n,k) and squared image intensity f²(m,n,k) within the ring window Q_{ρ}(i,j), where m,n are image point coordinates.

The mean square intensity deviation within the region S_{ρ}(i,j) have been used as the estimate of the region non-homogeneity, which is the local variance term d(i,j,k) in Eq. (2):

$${d}^{2} ( i , j , k ) = \frac{1}{\vert {S}_{ρ} \vert} {\sum }_{m , n ∈ {S}_{ρ} ( i , j )} {( {a}_{ρ} ( i , j , k ) - f ( m , n , k ) )}^{2} . \qquad ( 5 )$$

It is computed in the spatial saliency determinator 126 and subtracted from the local isotropic contrast, which is computed by the isotropic contrast operator 124.

The temporal change filter 106 in FIG. 1 executes the estimation of the temporal change term e(i,j,k) of the spatiotemporal attention operator according to Eq. (2) in all image points {(i,j,k)}. The temporal change is computed by applying the temporal differentiation filter and scale-adaptive spatial filter, which takes the discrete temporal derivative of the image sequence as its input. It is proportional to the amount of temporal change in image intensity for the consecutive frames in a given neighborhood of (i,j,k) considered as the center of a high-contrast homogeneous region belonging to an object of interest.

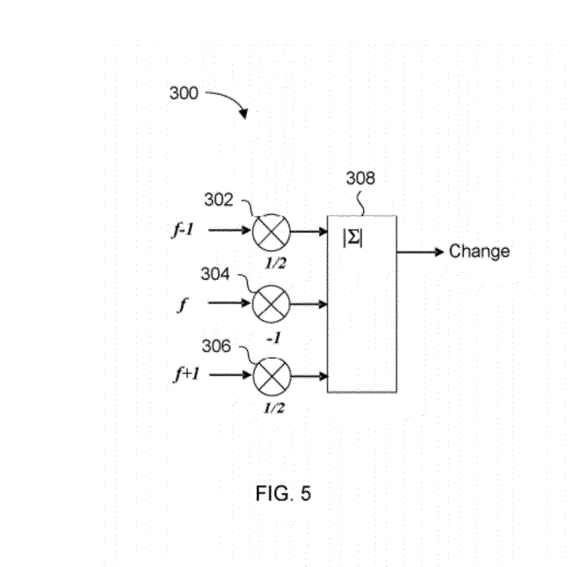

FIG. 5 is a block diagram of the temporal differentiation filter 118 shown in FIG. 1, according to a present embodiment. The temporal differentiation filter 300 includes three multipliers 302, 304 and 306, and a summer, or adder 308. Multiplier 302 receives a first frame f−1 and multiplies all pixel intensity values by a factor of 0.5. Multiplier 304 receives a second frame f and multiplies all pixel intensity values by a factor of −1.0. Multiplier 306 receives a third frame f+1 and multiplies all pixel intensity values by a factor of 0.5. While the present example of FIG. 5 uses multiplier factors of 0.5 and −1.0, different factors can be used instead. It is assumed that the selected factors are selected such that a sum=0 for static, unchanging frames provided to all the multipliers. Furthermore, the present example uses 3 sequential input frames. In alternate embodiments, any number of sequential input frames can be used, with suitable multiplier factors. Therefore, in the case where there is no movement of any features between the three input frames, then the net sum of their outputs should be zero. Otherwise, a non-zero sum of their outputs is an indicator that some change in feature position or size has taken place between the three input frames. The determination of movement can be continuous as each new frame that is received becomes frame f+1, while the previous f+1 and f frames are demoted to positions f−1 and f. For the embodiment of FIG. 5, all pixels of the image can be processed and the values stored on mass storage devices for later access. Alternately, a group of pixels within the window set by spatial local scale selector 104 for an image point can be processed for subsequent processing by scale-adaptive spatial filter 120.

As previously mentioned, the temporal differentiation filter of FIG. 5 with the differentiation step τ is composed of three multipliers and an adder and simultaneously handles three delayed frames of the input image sequence:

h(i,j,k)=|f(i,j,k−τ)−2·f(i,j,k)+f(i,j,k+τ)|/2. (6)

The differentiation step τ is determined by the minimal detectable temporal change or object movement. This three-frame differentiation has an advantage over the first-order differentiation in the estimation of temporal change. For a moving object region, the maximum of the temporal change will be located near the region center, whereas in the case of first-order differentiation it will be significantly displaced in the motion direction.

Scale-adaptive spatial filtering is applied to the temporal differentiation result by scale-adaptive spatial filter 120 at the output of the temporal differentiation filter. The scale-adaptive spatial filter 120 is configured as follows. An averaging over a circular window at the (ρ+1)th scale is used as the scale-adaptive spatial filter:

$$e ( i , j , k ) = \frac{1}{\vert {S}_{ρ + 1} \vert} {\sum }_{m , n ∈ {S}_{ρ + 1} ( i , j , k )} h ( m , n , k ) , \qquad ( 7 )$$

The integration of the difference image h(i,j,k) over the disk window S_{ρ+1}(i,j,k) according to Eq. (7) assumes the local maxima at the centers of salient regions of the objects of interest. As previously mentioned, The temporal change values from temporal differentiation filter 118 is summed up in scale-adaptive spatial filter 120 for all pixels located in the disk window centered in the point (i,j,k), i.e. in the neighbourhood S_{ρ+1} around (i,j,k). Since scale-adaptive spatial filter 120 is a filter device, it performs the same operation for all the image points. If the difference image at the output of temporal differentiation filter 118 is zero or has a low value, it means that there are no moving object or temporal changes in location (i,j,k).

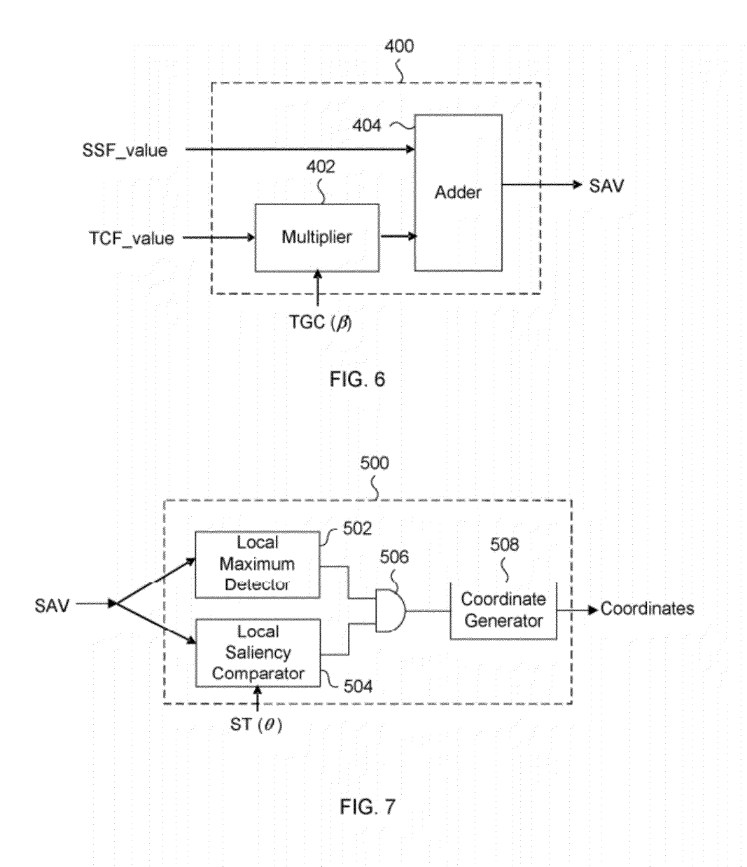

Further details of the spatiotemporal attention operator 110 of FIG. 1 now follows with reference to FIG. 6. FIG. 6 is a block diagram of a spatiotemporal attention operator, according to a present embodiment. The spatiotemporal attention operator 400 includes a multiplier 402 and an adder 404. The multiplier 402 receives the TCF_value from temporal change filter 106 for a pixel or image point, and multiplies it with the received variable temporal gain coefficient TGC (β). As previously mentioned, the variable temporal gain coefficient TGC (β) applies a weighting to the TCF_value, to effectively increase system sensitivity to moving features. The resulting output is provided to one input of adder 400. The other input of adder 400 receives SSF_value provided from spatial saliency filter 108 for a pixel. Both values received by adder 400 are summed together and provided as a spatiotemporal attention value (SAV).

The SAV result of the attention map computation at the output of the spatiotemporal attention operator 110 is fed to salient maxima filter 112 as shown in FIG. 1. A block diagram of the salient maxima filter 112 of FIG. 1 is shown in FIG. 7. The salient maxima filter 500 includes two computational blocks. First is a local maximum detector 502, and second is a local saliency comparator 504, both of which receive the SAV output from the spatiotemporal attention operator 110. The salient maxima filter 500 further includes a logical AND gate 506 and a coordinate generator 508, where the AND gate 506 receives outputs from the local maximum detector 502 and the local saliency comparator 504. The output of the AND gate 506 is provided to the coordinate generator 508. The local maximum detector 502 compares the intensity of the attention map in a given point with the intensity in the neighboring points to determine the local maximum condition. If SAV is the maximum intensity, then a true value is output. The local saliency comparator 504 generally determines if the value of SAV is at least the predetermined saliency threshold of ST(θ). If the value of SAV is at least ST(θ), then a true value is output. In the present example, a true value corresponds to a logic “1” value, whereas a false value corresponds to a logic “0” value. More specifically, the local saliency comparator 504 is configured to execute the following function:

$$ϕ ( i , j , k ) = \{ \begin{matrix}1 , & \frac{c ( i , j , k )}{d ( i , j , k )} > θ \\ 0 , & \frac{c ( i , j , k )}{d ( i , j , k )} \leq θ\end{matrix} , \qquad ( 8 )$$

where θ is the saliency threshold. Simultaneous satisfaction of local maximum and spatial saliency condition in Eq. (8) will result in indicating the point (i,j,k) as the center of object region by coordinate generator 508. Accordingly, an object has been detected in the image(s).

In comparison with the conventional differentiation approach, the scale-adaptive estimation of the temporal change and its integration with the spatial saliency in the proposed multi-scale attention system has three main advantages in detecting moving objects. First, it provides the location of a moving-object region at its geometrical center whereas the direct temporal differentiation usually gives the region edges in the motion direction. Second, its response to weak temporal changes will be stronger than that of the direct differentiation due to the scale-adaptive change integration over the disk region S_{ρ+1}(i,j,k). Third, the introduction of the coefficient β into the temporal change term in Eq. (2) allows the multi-scale attention system to control the detection priority of a moving object (or temporal change) over a non-moving one by simply increasing the coefficient β.

In the preceding description, for purposes of explanation, numerous details are set forth in order to provide a thorough understanding of the embodiments of the invention. However, it will be apparent to one skilled in the art that these specific details are not required in order to practice the invention. In other instances, well-known electrical structures and circuits are shown in block diagram form in order not to obscure the invention. For example, specific details are not provided as to whether the embodiments of the invention described herein are implemented as a software routine, hardware circuit, firmware, or a combination thereof.

Embodiments of the invention can be represented as a software product stored in a machine-readable medium (also referred to as a computer-readable medium, a processor-readable medium, or a computer usable medium having a computer-readable program code embodied therein). The machine-readable medium can be any suitable tangible medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention can also be stored on the machine-readable medium. Software running from the machine-readable medium can interface with circuitry to perform the described tasks.

The above-described embodiments of the invention are intended to be examples only. Alterations, modifications and variations can be effected to the particular embodiments by those of skill in the art without departing from the scope of the invention, which is defined solely by the claims appended hereto.

What is claimed is:

1. A method and multi-scale attention system comprising: a selector of spatial local scale connected with the local scale input of the spatial saliency filter and connected with the local scale input of the temporal change filter, which receive at their inputs an input image sequence, and their outputs are combined using a temporal gain coefficient in the block of spatiotemporal attention operator, which is further connected to the filter of salient maxima, which output indicates the coordinates of centers of objects of interest or temporal change regions in the image sequence.

2. The method and multi-scale attention system according to claim 1, in which the spatial saliency filter comprises: the block of averaging filters using disk averaging window and ring averaging window, which are linearly combined in the isotropic contrast operator to estimate the local isotropic contrast; the block of spatial saliency function, which computes the local variance in the disk window and subtract it from the output of the isotropic contrast operator to produces the spatial saliency level in the current location of the input image sequence.

3. The method and multi-scale attention system according to claim 1, in which the temporal change filter comprises the temporal differentiation filter which is connected with the scale-adaptive spatial filter, which output produces the temporal change level in the current location of the input image sequence.

4. The method and multi-scale attention system according to claim 1, in which the selector of spatial local scale is composed of a bank of R blocks of the local averaging filters connected with R estimators of contrast-to-variance ratio, which outputs are connected with R inputs of the maximum selector, which output provides the spatial local scale value, where R is the total number of spatial local scales.

5. The method and multi-scale attention system according to claim 1, in which spatial local scale is determined in each image point and is an estimate for the local size of the objects of interest, which thereafter is used to determine the spatial saliency level and the temporal change level in all image points of the input image sequence.

6. The method and multi-scale attention system according to claim 1, in which the spatial saliency level in each image point is determined by the ratio of the local isotropic contrast to the local variance over a circular region, which diameter is equal to the spatial local scale value in pixels for the corresponding image point.

7. The method and multi-scale attention system according to claim 1, further comprising: the spatiotemporal attention operator, which adds the temporal change level multiplied by the temporal gain coefficient to the spatial saliency level, which is at the output of the spatial saliency filter.

8. The method and multi-scale attention system according to claim 1, further comprising: the filter of salient maxima, which includes the local maximum selector and the saliency comparator connected through the logical “and” operation to the input of the coordinate indicator, which output is the object location point in the image sequence or center of the temporal change region in the image sequence; another input of the saliency comparator is fed by the saliency threshold.

9. The method and multi-scale attention system according to claim 1, in which the temporal differentiation filter implements the second-order discrete differentiation by linearly combining current image frame, previous image frame and next image frame with the corresponding coefficients to form the output of the temporal differentiation filter.

10. The method and multi-scale attention system according to claim 1, in which the computation of the local isotropic contrast, local variance and spatial saliency level proceeds in a multi-scale mode for all the R spatial local scales, where R is the total number of spatial local scales, and the total number of the spatial local scales R is selected so to cover all the possible local sizes of the objects of interest and temporal change regions to be detected.
